(19) United States
(12) Patent Application Publication
(10) Pub. No.: US 2006/0265661 A1
(43) Pub. Date: Nov. 23, 2006

(54) Device metadata

(75) Inventor: Steven J. Ball, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/134,150

(22) Filed: May 20, 2005

(51) Int. Cl. G06F 9/00

(52) U.S. Cl. 715/734

(57) ABSTRACT

Rich device metadata describing detailed attributes of peripheral devices can be used to provide device-oriented user interfaces for realistically and accurately displaying, visualizing, controlling or managing devices. Vendors of personal computers, electronics devices, or peripheral devices can provide standardized rich device metadata. An intermediary service or system can, via a network, collect the rich device metadata, validate it, and store it. User computers to which peripheral devices are connected can pull rich device metadata for their peripheral devices. The rich device metadata can then be used to manage the devices and/or to provide more realistic virtualizations of the peripheral devices. Realistic representations of the devices can be displayed. Attributes such as controls and connectors on the device can be represented in the metadata and displayed and possibly interacted with. Devices can be nested in the metadata. Rich device metadata can be extended over time. If a user does not know exactly which device is connected then a fuzzy search including possibly a fuzzy image matching process can be used to obtain a match or narrow a search to contain a list of possible devices that the user can select from.

### TECHNICAL FIELD

This description relates generally to device metadata and more specifically to an intermediary service to provide device metadata to user computers and techniques for user computers to obtain and use rich device metadata.

### BACKGROUND

General purpose computing devices such as workstations, PCs, servers, handhelds, PDAs, cellphones, and others, commonly host or connect with a wide variety of local or peripheral devices or components. Flash memory cards, PCI cards, local printers, disk drives, bus controllers, speakers, displays, input devices, modems, ports, wireless headphones, uninterruptible power supplies, cameras, webcams, portable music players, cellphones, televisions, and network cards, are only a few examples of the wide range of peripheral devices commonly connected with a computer, both inside and outside the computer case. Even a computer's unintelligent powerstrip can be considered to be a peripheral device. FIG. 1 shows just one example of how peripheral devices 100 are sometimes arranged for connection with a host computer.

A computer is often provided with software for a user to manipulate, configure, test, or manage the devices attached to and inside the machine. However, user experiences with device-oriented software have traditionally been poor. In particular, the device information displayed to a user may be static and may not parallel or reflect the actual appearance and physical characteristics of the specific devices connected to the computer. Consider the following.

FIG. 2 shows a user interface 120 for device management and control. The user interface 120 is for a device manager, which is a program or software module for managing a computer's peripheral devices. The user interface 120 has device representations 122 corresponding to devices connected with the host computer. As has been common in the art, the device representations 122 are simple generic images that are the same for all devices in a same category. For example, all three of the computer's network adapters are represented by the same generic icon 124. FIG. 3 shows a user interface 140 of a utility program for viewing information about a display adapter, changing settings of the display adapter, updating firmware of the display adapter, managing the state of the adapter, etc. The displayed device information 142 is limited and the representation 144 of the device does not reflect the appearance of a display adapter let alone the appearance of the specific display adapter being referred to.

Unrealistic or generic device representation has been common in the software arts. Computers have often had little or no descriptive information about peripheral devices. Device information that has been available has been static and flat. Furthermore, device information has not been available from a network-based service or intermediary that acts as a common collector and distributor of device information.

### SUMMARY

The following summary is included only to introduce some concepts discussed in the Detailed Description below. This summary is not comprehensive and is not intended to delineate the scope of protectable subject matter.

Rich device metadata describing detailed attributes of peripheral devices can be contributed, collected, and distributed to device users. Vendors of peripheral devices can contribute standardized rich device metadata. An intermediary service or system can collect the rich device metadata, validate it, and store it. Users of computers to which peripheral devices are connected can pull the rich device metadata for their devices. The rich device metadata can then be used on the user computers to provide more realistic virtualizations and control of the peripheral devices. Realistic representations of the devices can be displayed. Attributes such as controls and connectors on the device can be displayed and possibly used for interaction and control. Devices can also be nested in the metadata with parent/child relationships between one device or function that exists within another device. The schematic structuring and content of rich device metadata can be extended and expanded over time. If a user does not know exactly which device is connected then a fuzzy search can be used to obtain a list of devices that the user can select from.

Many of the attendant features will be more readily appreciated as the same become better understood by reference to the following detailed description considered in connection with the accompanying drawings.

### DESCRIPTION OF THE DRAWINGS

The present description will be better understood from the following Detailed Description read in light of the accompanying Drawings, wherein:

FIG. 1 shows an example of how peripheral devices are sometimes arranged for connection with a host computer.

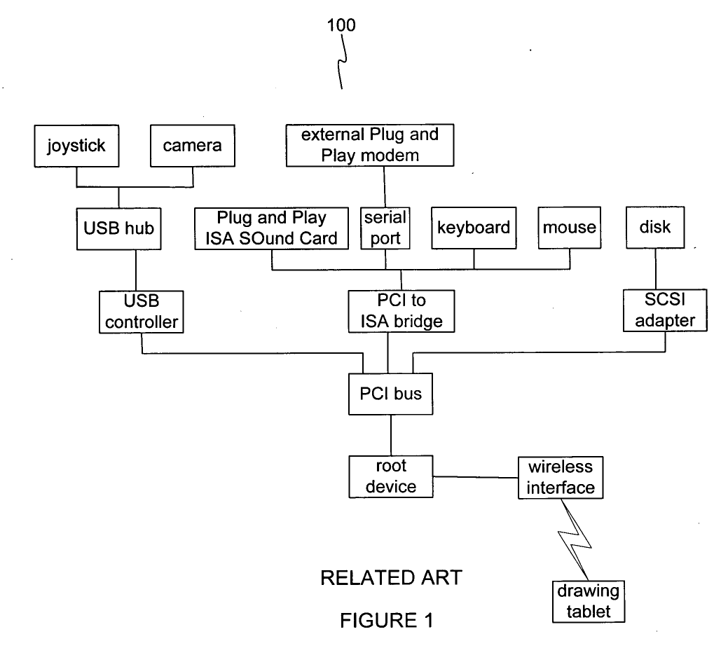

FIG. 2 shows a user interface for device management and control.

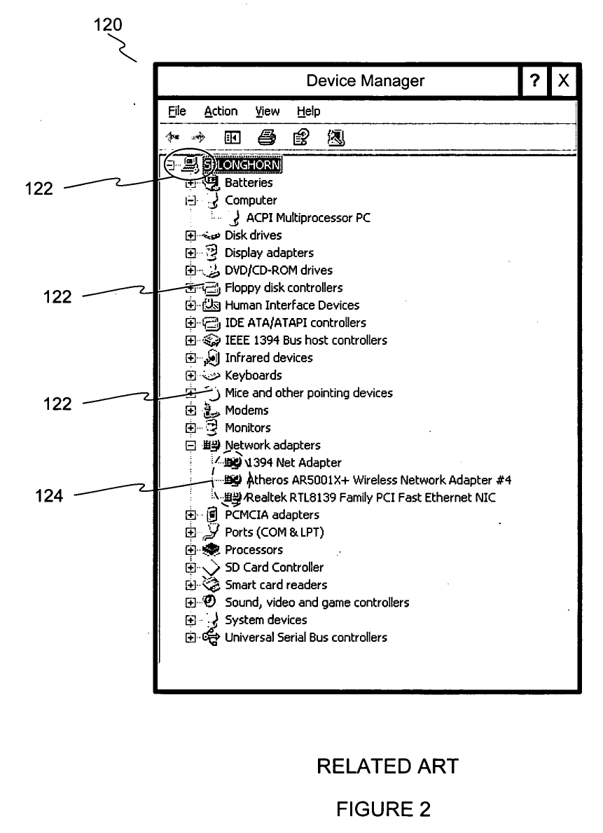

FIG. 3 shows a user interface of a utility program for viewing information about a display adapter, changing settings of the display adapter, updating firmware of the display adapter, managing the state of the adapter, etc.

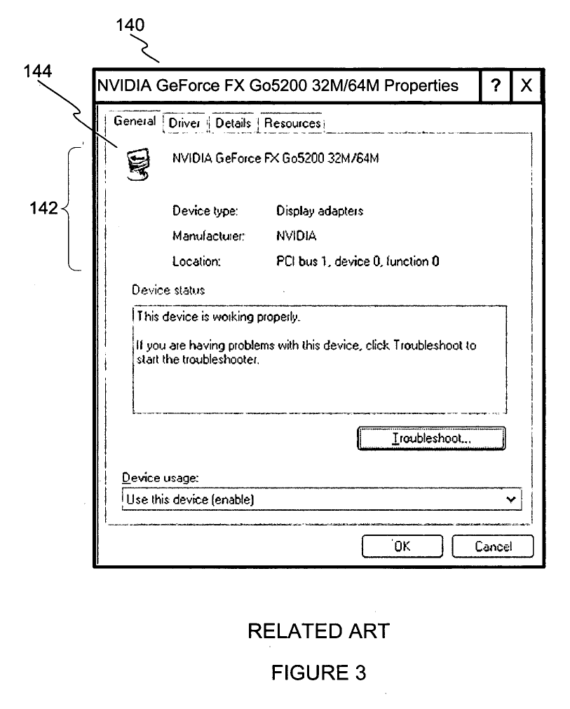

FIG. 4 shows how a device-oriented user interface can be improved using rich device metadata so that the device representation in the user interface closely matches reality.

FIG. 5 shows an example of rich device metadata.

FIG. 6 shows a device metadata intermediary service.

FIG. 7 shows one way a computer can benefit from a device metadata distribution service.

FIG. 8 shows an example of a device metadata distribution scenario.

FIG. 9 shows a fuzzy device metadata search process.

FIG. 10 shows a user interface for formulating a device search.

FIG. 11 shows a process for updating or supplementing device metadata.

FIG. 12 shows an example of dynamically extending device metadata.

Like reference numerals are used to designate like parts in the accompanying Drawings.

### DETAILED DESCRIPTION

Overview

As discussed above, device representations within device-oriented user interfaces have been unrealistic and inflexible. More sophisticated representations of a computer and its peripheral devices can enable a user interface with realistic device representations that look and feel like the devices that they represent. Accurately representing a computer and its attached devices can make it possible for ordinary users to manipulate, configure, test, and manage their attached devices in a “what-you-see-is-what-you-get” manner. That is, graphical user interfaces used to control the devices can look, feel, and behave in a way that reflects the physical devices themselves.

An enriched user experience has not been possible because accurate and in-depth device information has not been widely available, perhaps because there are literally millions of existing peripheral devices connected with and inserted within computers, and perhaps also because there has not been any mechanism for delivering rich device metadata (images, information, functionality details, etc.) that could allow a device-oriented user interface to accurately and realistically represent the appearance and/or capabilities of devices. As discussed in detail below, device-oriented user interfaces can be improved by providing a common format or schema for rich device metadata, by providing a common framework for delivering such rich device metadata, and/or by providing computers with the ability to intelligently determine and acquire the rich device metadata that they might need.

Device Metadata

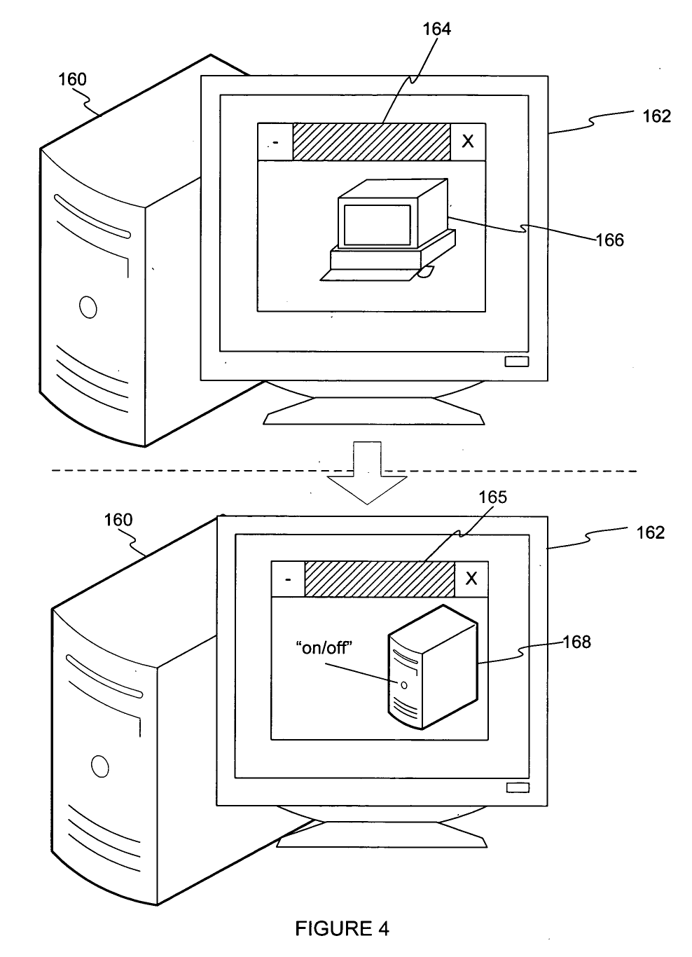

FIG. 4 shows how a device-oriented user interface can be improved using rich device metadata so that the device representation in the user interface closely matches physical reality or the user's perception thereof. In FIG. 4 a desktop computer 160 is coupled to a display 162. The display 162 is shown displaying user interfaces 164 and 165. The user interface 164 in the top half of FIG. 4 does not use rich device metadata to represent, in this case, the desktop computer 160 itself (or its case). Consequently, the representation 166 of the desktop computer/case 160 is unrealistic and incomplete. If rich device metadata (discussed further below) is used, then a more realistic representation and interface model becomes possible. The user interface 165 in the lower half of FIG. 4 uses rich device metadata about the desktop computer/case 160 to represent the desktop computer/case 160, resulting in a realistic representation 168. Note that representation 168 matches the appearance of the desktop computer/case 160. If information about hardware controls on the computer/case 160 is included in the rich device metadata, then the user interface 165 can use the rich device metadata to point out such specific features of the computer/case 160, for example the “on/off” switch displayed in user interface 165. Display of this information may be triggered by using an input device such as a mouse to interactively indicate the “on/off” switch on the representation 168. Similarly, a user could interact with representation 168 to learn about a CD tray or drive bay on the front of computer/case 160. Other enhancements can also be provided given sufficient device metadata information. For example, if a mesh model or Virtual Reality Modeling Language (VRML) model of the computer/case 160 is included in the rich device metadata, then representation 168 could be three-dimensionally manipulated or navigated. A user could interactively reorient the representation 168 to display the back of representation 168. Given sufficient device metadata, the user interface 165 can be designed to allow the user to explore and discover the properties of graphical slots and connectors on the back of representation 168, and so on.

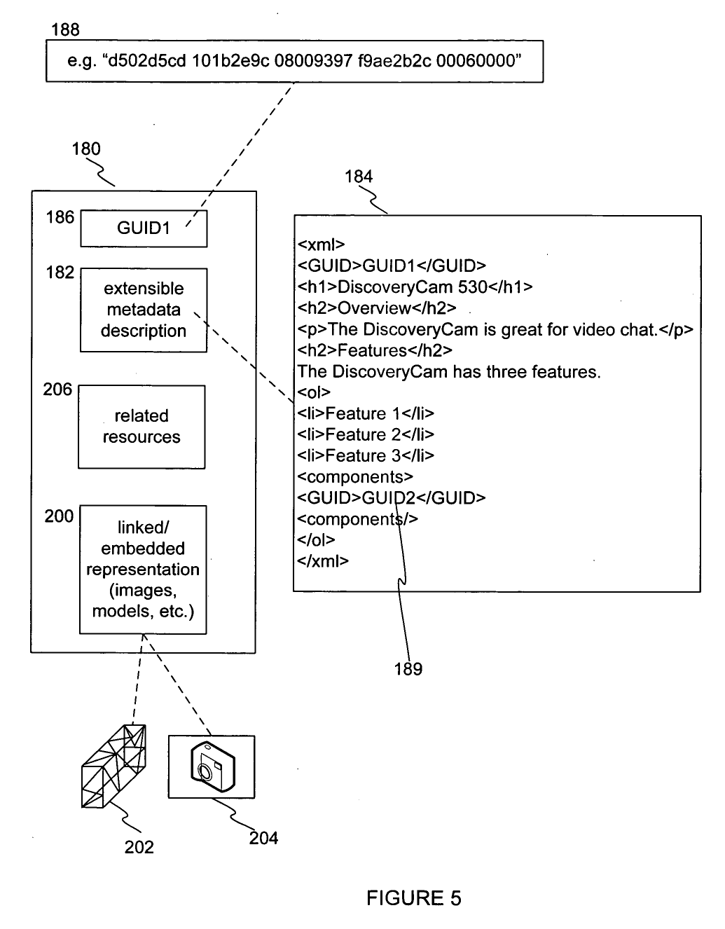

FIG. 5 shows an example of rich device metadata. Rich device metadata may be provided in discrete units or blobs, such as the piece of device metadata 180 shown in FIG. 5. The piece of device metadata 180 in its most basic implementation will include description information or metadata 182 about a corresponding device. Description metadata 182 will preferably include information pertaining to traits and characteristics of a specific device. Description metadata 182 may include physical attribute information such as size, weight, color, shape, materials, etc. Description metadata 182 may also include functional attribute information, which is defined herein to include information such as type of general device category, or connections (inputs and outputs), or switches and other controls, or supported standards, or code or software residing and executing on a device, or other functionality. For example a display device might have functional information such as pixel size, a speaker device might have functional information such as speaker watts, etc. The description metadata 182 is preferably hierarchical in that elements can be extended with additional information about the device, including references to or inclusions of pieces of device metadata corresponding to components of the device (see e.g. the “components” element in XML snippet 184).

The description metadata 182 may be implemented using Extensible Markup Language (XML), such as the XML snippet 184 shown in FIG. 5. Any other markup language derived from Standardized General Markup Language (SGML) may be used. Any description language or convention for sharing extensible meta-information about a device may be used. If a markup language is used, a vendor or other metadata information provider can submit something like an electronic product specification or brochure as long as expected markings delineate the relevant description information.

The piece of device metadata 180 for a device may also include a globally unique identifier (GUID) 186. While a GUID may superficially resemble older identification schemes like the UPC system, in fact previous device identification schemes have been insufficient for providing a quality device-oriented user interface experience. Consider that a person can go to a store and buy a device that has a UPC that identifies the manufacturer and commercial device that is being sold. However, that UPC code does not map back to or have any connection to the actual shape, color, description, functions, or details of the product group the code covers. The UPC code is analogous to a zip code in that it defines a sort of product neighborhood but does not define the specific address (or picture and description of) of each individual house in that neighborhood. With the UPC, the manufacturer may decide that two devices will have a same UPC even though there are functional or visual differences between those devices. A well designed GUID system will have a highly granular level of device identification.

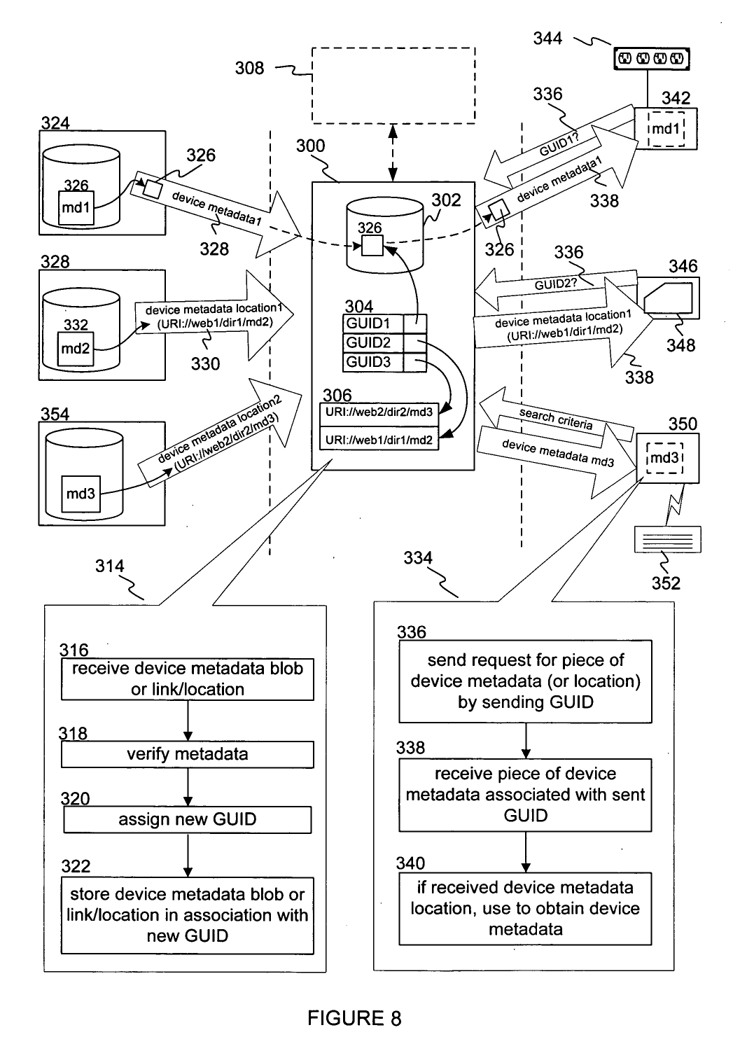

A GUID 186 may be a hash of some its device's features. Example GUID 188 in FIG. 5 might have four parts or codes; a manufacturer code, a general product code, a specific product code, and a code or hash of specific features. In other words, a GUID may map to the specific device that it uniquely represents. An embedded GUID will be helpful for some implementations of device metadata distribution (e.g. a peer-to-peer distribution system), however, a GUID need not be formally included within its device's metadata but rather may be externally associated with its device's metadata via a table, index, etc. (see FIG. 8).

Note that device metadata 180 may be nested. That is, a piece of device metadata can reference or include a piece of device metadata for a device that it is connected to or is one of its parts. For example, XML snippet 184 has a nested GUID 189 of another device; “GUID2”.

A device's piece of metadata 180 can also include representation information 200, which might include an embedded 3D mesh model 202, an image 204, or some other information (e.g. VRML) providing a realistic virtual representation of the corresponding device. This representation information 200 may be supplemented with information about the location of components of the device, for example model 202 may include information indicating that a USB connector (detailed in the device's metadata) is located at some position x,y,z, or representation information 200 may include information indicating that an “on/off” switch is at location x,y of image 204.

A device's metadata may also include references to sources of information 206 related to the device, such as a URL pointing to a website of a manufacturer or seller, a link to a product manual, a device directory address, and so on.

In sum, rich device metadata with device-specific appearance and/or functional information about a device can be used by a device-oriented user interface to provide a realistic virtual device experience.

Device Metadata Intermediatary Service

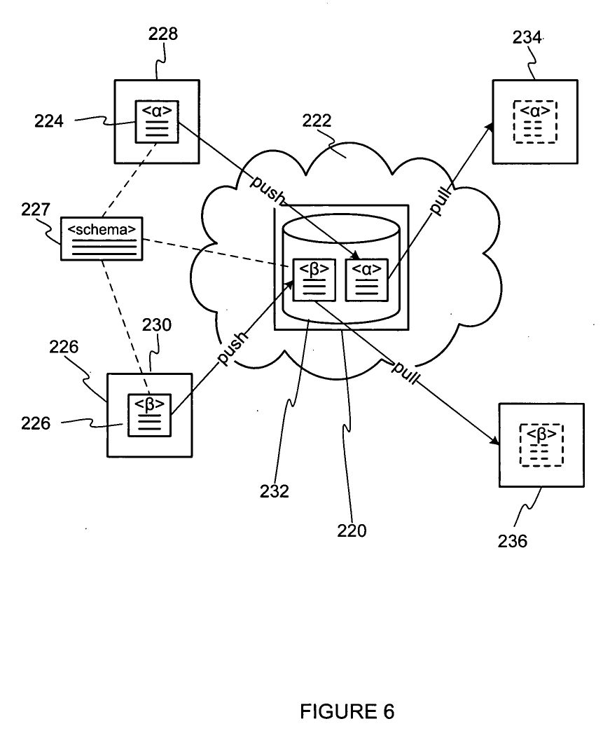

FIG. 6 shows a device metadata intermediary service. As mentioned previously, changing how devices are virtually presented to users can be difficult because of the large existing base of devices installed in or connected with computers. Although individual computers can communicate directly with different device manufacturers to obtain device information, this many-to-many approach is unreliable and standardization is difficult to enforce. By providing an intermediary service for distributing device metadata to user computers, it becomes possible to reliably and transparently collect and distribute rich device metadata while ensuring the device metadata is consistently organized, structured, marked-up, etc. When contributors and consumers of device metadata base their indirect exchange of device information on a standard way of arranging individual pieces of device metadata, e.g. by sharing or conforming to a common or standard device metadata schema, then a device-oriented graphical user interface can be designed to provide realistic virtualizations for any type of device.

Referring again to FIG. 6, at the core of such a device metadata intermediary service is a distribution system 220, for example a server or network of cooperating servers, a peer-to-peer network, etc. By way of a data network 222, the distribution system 220 functions as both a collector and distributor of device metadata. The distribution system 220 collects device metadata 224, 226 (corresponding to respective different devices) preferably pushed across network 222 by one or more contributor computers 228, 230. The device metadata 224, 226 preferably conforms to an established common or published standard, possibly in the form of a schema 227 such as an XML Schema Definition (“XSD”). The distribution system 220 has a storage mechanism 232 (e.g. a data store, database, or even a simple collection of files) for storing the collected pieces of device metadata 224, 226. In one embodiment the distribution system 220 may verify the device metadata (e.g. for compliance with a standard schema), or check the integrity of the device metadata using a checksum or the like, or authenticate the sender of the device metadata. Verification may include validating a piece of device metadata against the published metadata standard, common XSD file, etc. These checks may be performed either before storing the device metadata or before making the device metadata available to requesting computers 234, 236. Requesting computers 234, 236 may pull device metadata as needed; usually at some time after the device metadata has been supplied to the distribution system 220. For example, if requesting computer 234 determines that it needs the device metadata for a device α then it pulls the device's metadata 224 from the distribution system 220.

Note that requesting computers 234, 236 may not actually have the devices for the respective pieces of device metadata 224, 226. Note also that the network 222 could in reality actually be a number of different networks. The supplying and requesting computers can be any variety of types of computers. Pushing device metadata to the distribution system 220 is preferable but not necessary; batch-type data pulling can also be used. Similarly, pulling device metadata from the distribution system 220 is preferable but not the only way to obtain device metadata. For example, a requesting computer 234, 236 could register for regular device metadata updates and the distribution system could accordingly email or otherwise push device metadata to the ultimate users of the device metadata. However, transparent acquisition is preferable.

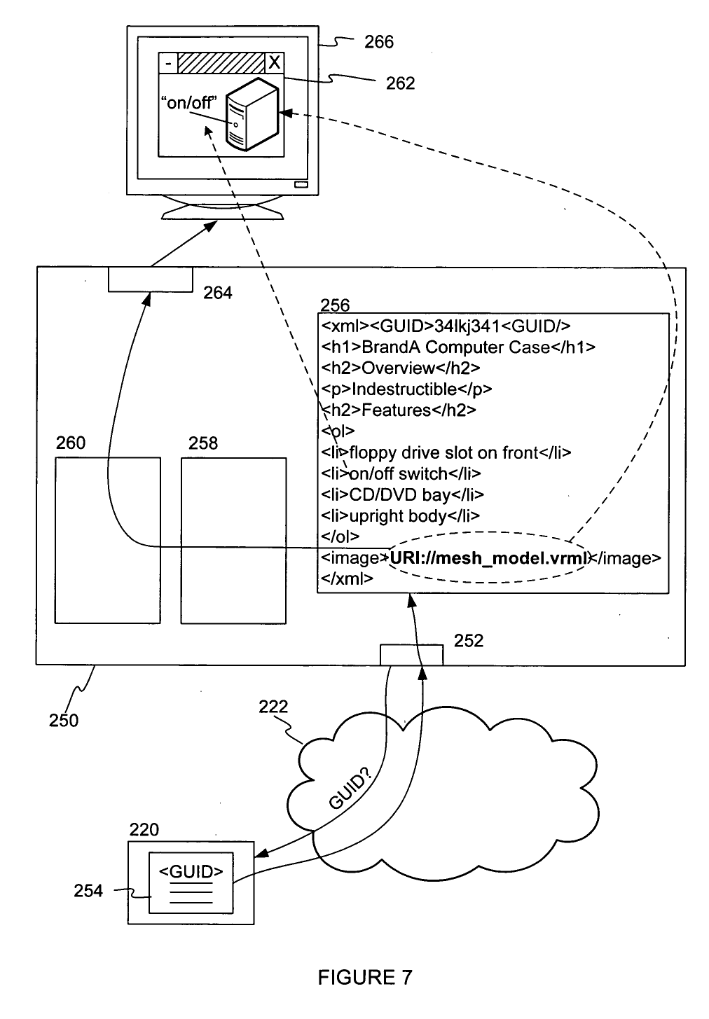

FIG. 7 shows one way a computer 234/236/250 can benefit from a device metadata distribution service. In FIG. 7, user computer 250 sends a request via a network interface 252 and network 222, possibly sending a GUID for a particular device. The distribution system 220 responds by sending a piece of device metadata 254 corresponding to the requested GUID. The computer 250 stores a local copy 256 of the device metadata 254. A metadata language parser 258 parses the device metadata 256 and passes extracted device information to an application 260. The application 260 can use the device information in any number of ways discussed above. If the application 260 has a user interface 262, display adapter 264, and display 266, then it can render or display a realistic representation of the device corresponding to the GUID. If the device information includes details about connectors or controls of the relevant device, e.g. information about an “on/off” switch, then the user interface 262 can display the same and can potentially be used to allow a user to actually control the device. For example, a representation of an “on/off” switch could be interacted with to turn a device on or off. In sum, by using a device intermediary service a computer can provide a rich device-oriented user interface experience.

FIG. 8 shows an example of a device metadata distribution scenario. Again, a distribution system 300 is the medium of device metadata exchange. The distribution system 300 has: a database or storage 302 for storing pieces or blobs of device metadata; a GUID table 304 for storing and generating GUIDs; and a resource location table 306. The distribution system 300 may cooperate with a peer or server 308 to exchange device metadata or otherwise cooperatively provide a service for collecting and providing device metadata.

FIG. 8 shows several ways that device metadata can be contributed, collected, accumulated, and distributed. A first approach is the collection and distribution of device metadata itself. A second approach is the collection and distribution of the locations of device metadata (e.g. URLs, URIs, etc.) rather than the device metadata itself. Either or both approaches may be used. In either case, when a location or chunk of device metadata arrives at distribution system 300, the system 300 performs a process 314, namely, receiving 316 the location or piece of device metadata, verifying 318 the validity, integrity, and/or authenticity of the device metadata, assigning 320 a new GUID if the device metadata does not extend or replace existing device metadata, and storing 322 the device metadata in storage 302 (or storing 322 the metadata location in the resource location table 306). A new GUID can be calculated, for example, as a hash of the new device metadata, or as a serial counter, or a combination thereof. A new GUID is stored in GUID table 304.

Preferably, participating computers, in particular at least contributing computers, are provided with copies of a same/common device metadata schema that provides a common hierarchical structure or framework that pieces of device metadata should conform to. With or without a schema file, a contributing computer may build an outgoing piece of device metadata, e.g. 224/254/256/326, to conform to the common schema; device data may be marked up with tags named and hierarchically arranged according to the common schema. This allows the distribution system 300 to validate incoming device metadata thereby assuring that computers later requesting device metadata will receive device information in a form that is readily usable and that can be used in similar ways on many different computers. For instance, it could be assured that a same device manager realized on many different computers could understand and use same pieces of device metadata. As discussed further below, this approach also allows device metadata to be extended over time. For example if information such as richer or deeper information about devices, 3D models of devices, or new mechanisms for visualizing devices or 3D objects becomes available in the future, that information can be passed on to people who obtain or already possess such devices.

In FIG. 8, computer 324 takes the first approach of submitting a piece of device metadata 326. Computer 324 sends 328 the device metadata 326 to distribution system 300. Distribution system 300 receives 316 the device metadata 326, verifies 318 the device metadata 326, assigns 320 new GUID1, stores GUID1 in GUID table 304, and stores the device metadata 326 into the storage 302. Computer 328 uses the second approach and sends 330 device metadata location 332 (e.g. URI://web1/dir1/md2), which is any form of network location information (e.g. hostname and directory, etc.) where the actual device metadata, file “md2”, can be obtained. Distribution system 300 receives 316 the device metadata location 332, optionally verifies 318 the device metadata (“md2”), assigns 320 new GUID2 if necessary, and stores the device metadata location 332 in resource location table 306.

User computers may request or pull device metadata information from the distribution system 300. A pull process 334 may involve sending 336 a request for a location or piece of device metadata associated with a particular GUID, receiving 338 same, and if the device metadata information is a location, using it to obtain 340 the actual device metadata. If computer 342 needs device metadata for its power strip device 344, then it sends 336 GUID1 to distribution system 300 and receives 338 a copy of corresponding device metadata 326. If computer 346 needs device metadata for its flash memory card 348 then it sends 336 GUID2 and receives 338 the device metadata location 330. As mentioned above, a combination of approaches may be used. For example, if computer 350 needs device metadata for its keyboard 352 it can submit a search criterion that matches to device metadata “md3”. The distribution system 300 can use its location of “md3” (in resource location table 306) to pull the actual piece of device metadata and forward same to computer 350, perhaps caching or storing a copy for later use if the location for “md3” becomes unavailable, e.g. host 354 is offline. This combined approach may provide more up-to-date device metadata but can also lead to a slower response time.

The device metadata intermediary service can be based on a custom framework protocol or it can based on any number of standard metadata information sharing frameworks, such as the Open Archives Initiative Protocol for Metadata Harvesting (OAI PMH), a description of which is available at www.openarchives.org/OAI/openarchivesprotocol.html, the Resource Description Framework (RDF), a 1999 W3C Recommendation which is available at www.w3.org/RDF, and others.

Although embodiments above have device metadata providers (e.g. vendors) contributing device information in the form of device metadata, device information can be contributed in other ways. For example, parties responsible for providing information about devices can access a secure data input mechanism such as a web input form served by the intermediary service. From the web input form device information of a nature discussed above can be entered and submitted to the intermediary service. When submitted, the intermediary service converts the inputted device information into device metadata which is then stored and distributed by the intermediary service. Furthermore, the device information may be stored in a hierarchical database rather than in the form of a metadata language. When metadata for a device is requested the device's information is pulled from the database and then formatted as metadata before being sent to a requesting computer.

Device Metadata Acquisition and Use

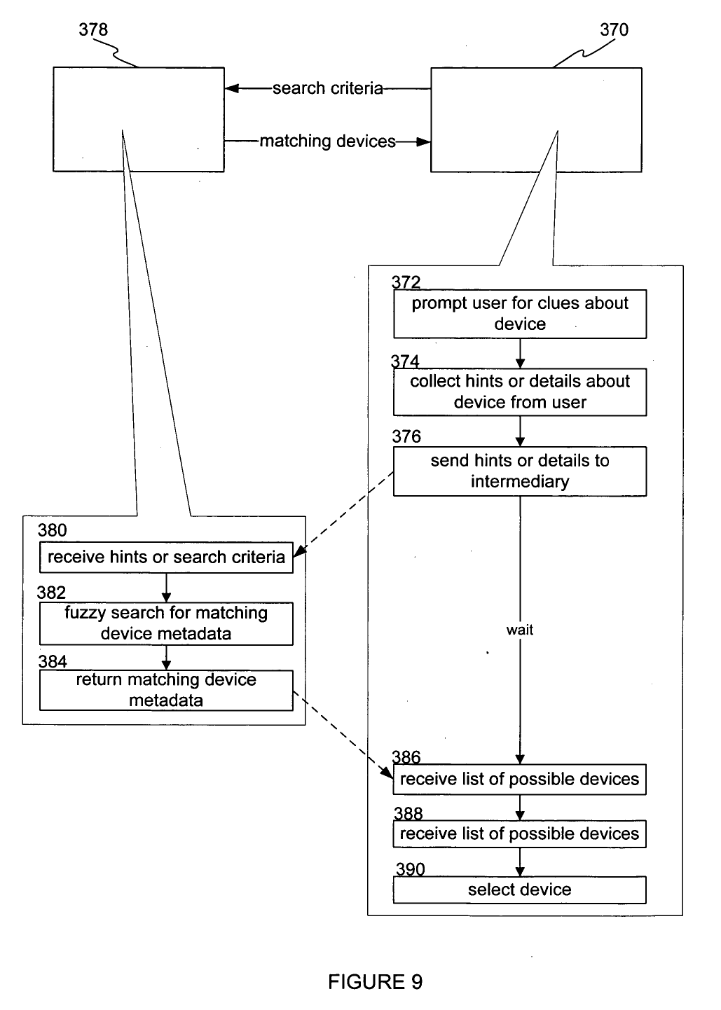

FIG. 9 shows a fuzzy device metadata search process. When a querying computer such as user computer 370 does not know the precise device for which it needs device metadata then a fuzzy search process may be used. The computer 370 may start by prompting 372 the user for clues about the device. For example, the computer 370 could ask the user what color the device is, who the manufacturer is, what type of device it is, and so on. The computer may also ask the user to provide an image of the object to be matched or request the user to point a camera, webcam scanner or other image capture device at the object which needs to be matched. The computer 370 collects 374 these hints and other data and sends 376 them via a network to the intermediary such as distribution system 378. Distribution system 378 receives 380 the hints and other information and searches 382 for fuzzy matching device metadata. If image data is received, a fuzzy graphics algorithm at the metadata service may be used to analyze and closely match the device in question with other devices that match its outline, color scheme, shape, salient features, or other physical characteristics that may be determined programmatically from the image data. The matching device metadata is returned 384 via the network to the requesting computer 370. The computer 370 receives 386 the matching devices, displays 388 them to the user, and the user selects 390 the correct one.

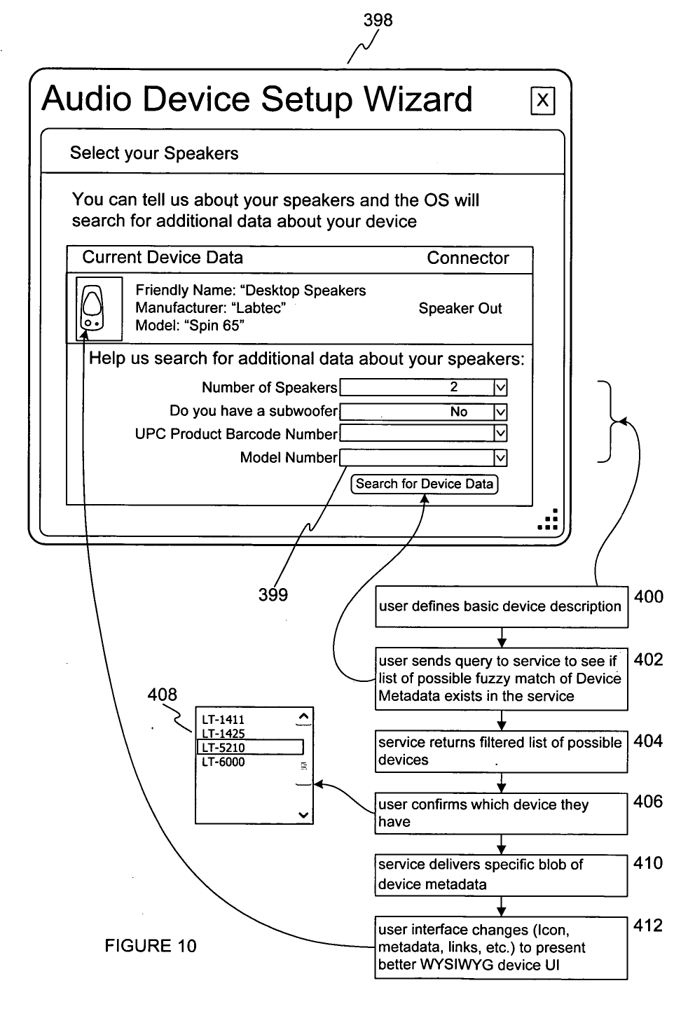

FIG. 10 shows a user interface 398 for formulating a device search. The user may start by using dropdown selection lists 399 to define 400 basic device information. Dropdown selection lists 399 (or tree controls, or other common selection mechanisms) may be formulated based on the type of device to be identified. After defining 400 the basic device information the user sends 402 a query to the intermediary service. The intermediary service returns 404 a list of possible devices. The user confirms 406 which device they actually have, for example using a selection list 408. If the intermediary service did not include device metadata with the returned 404 list of possible devices, then the service delivers 410 the confirmed 406 piece or blob of device metadata. Once the user's computer has the requested device metadata it can begin to provide a more realistic device-oriented user interface. For example, any of the user interfaces 120, 140, 165, 262, or 398 can be changed 412 to display a realistic representation of the device corresponding to the obtained device metadata, or to display functional attributes such as connections or controls of the device, and so on.

An advantage of using a metadata format for the device information is that a device's information can be supplemented or extended with attributes, elements, etc. that could not have been anticipated when the device or its metadata was originally issued. If a vendor of a device issues a new firmware update for the device that the vendor knows will expose new functionality for the device, then the vendor will likely know that the metadata for that device will need to be updated or extended to reflect the newly exposed functionality. The intermediary system can be designed to accommodate this and deliver the latest status, metadata, firmware, software, images, mesh files, pricing information, distribution, controls, software, manufacturer information location or other useful data objects that describe the device.

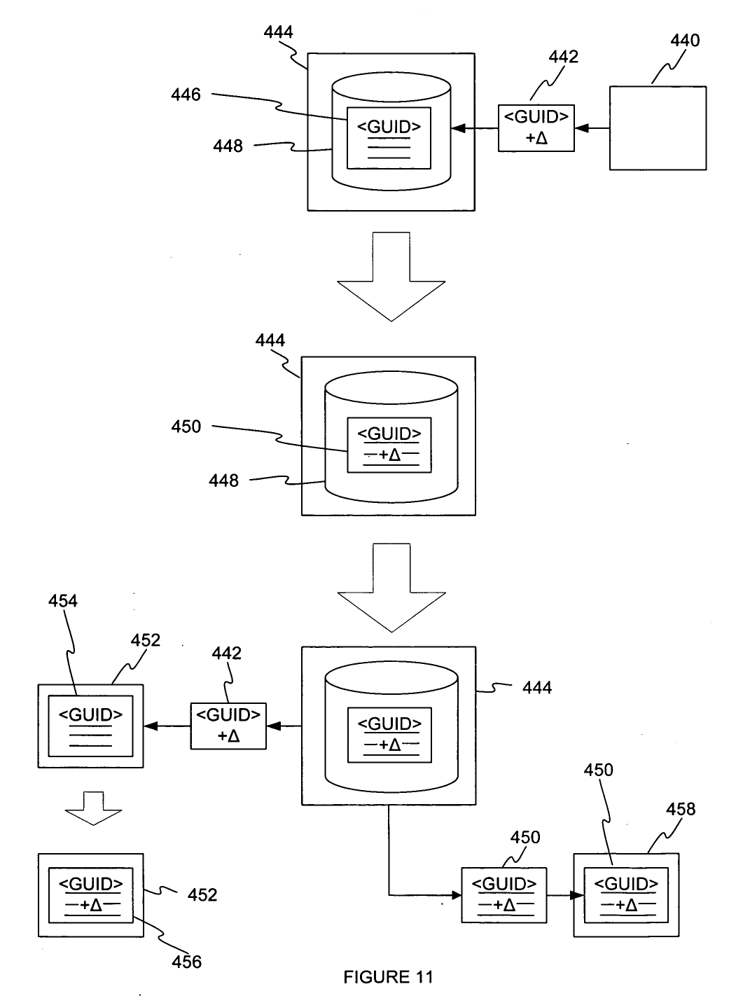

FIG. 11 shows a process for updating or supplementing device metadata. A vendor 440 sends a delta of new device metadata 442 for an existing device, preferably accompanied by the GUID for that device. The intermediary service 444 receives the delta metadata 442 and extends the device's metadata 446 that is stored in the intermediary's 444 data store 448. This might involve adding a new XML element to an existing element of the device metadata 446. The result is an extended device metadata 450. If the intermediary 444 maintains a list of computers that have pulled a device's metadata then the intermediary 444 may push out the delta metadata 444 to those computers. For example, user computer 452 could receive the delta metadata 442 and extend its existing device metadata 454 resulting in an extended piece of device metadata 456. A computer 458 sending a request for the device's metadata would receive the extended device metadata 450.

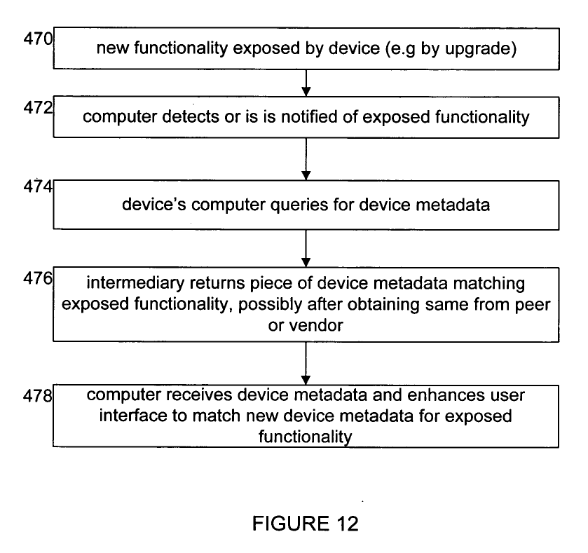

FIG. 12 shows an example of dynamically extending device metadata. A user computer with a peripheral device such as a wireless modem might upgrade the firmware for its wireless modem. The upgrade might expose 470 new functionality of the wireless modem, for example the upgrade may add support for a specific industry-standard set of modem commands. The firmware upgrade might cause 472 the computer to query 474 the device metadata intermediary for new metadata about its wireless modem. The intermediary returns 476 the requested device metadata. When the user computer receives 478 the new metadata (presumably already extended by the modem's vendor) it can automatically use the new metadata as a basis for improving or extending its user interface for managing the device to reflect, for example, that the new command set is supported by the wireless modem.

With device metadata extensibility, device-oriented user interfaces can be changed to take advantage of new types of device information or to display new forms of device representation, without having to redesign or replace the underlying device metadata distribution framework and possibly without having to reprogram a user interface that uses device metadata.

### SUMMARY

Providing users with rich and accurate information about their devices can be facilitated in any number of ways discussed above. Rich device metadata is a key to improving the information available to users about their devices. Previous operating systems and device-oriented programs have not had a central place to expose device metadata for average users in a way that is useful for visualization or control of those devices. Providing a system for centrally distributing device information can also be useful.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Those skilled in the art will also realize that a variety of well-known types of computing systems, networks, and hardware devices, such as workstations, personal computers, PDAs, mobile devices, and so on, may be used to implement embodiments discussed herein. Such systems and their typical components including CPUs, memory, storage devices, network interfaces, operating systems, application programs, etc. are well known and detailed description thereof is unnecessary and omitted.

1. A method performed by an intermediary device residing on a network between source computers that supply device metadata via the network and user computers that request device metadata via the network, the method comprising:
at the intermediary, via the network, receiving from different source computers units of information describing functional attributes and/or the appearances of respective different peripheral devices;
at the intermediary, storing pieces of device metadata describing the functional attributes and/or including visual representations of the respective different peripheral devices or machines, where the pieces of device metadata conform to a standard metadata schema for describing and uniquely identifying peripheral devices;
at the intermediary, via the network, receiving from different user computers requests for device metadata; and
responsive to requests for device metadata from requesting computers, sending via the network to the requesting user computers the stored pieces of device metadata corresponding to different peripheral devices and conforming to the standard metadata schema.

2. A method according to claim 1, wherein the received units of information comprise pieces of device metadata.

3. A method according to claim 2, further comprising the intermediary device validating a received piece of device metadata against the device metadata schema.

4. A method according to claim 1, further comprising the intermediary device assigning globally unique device identifiers (GUIDs) for the pieces of metadata corresponding to different devices.

5. A method according to claim 4, wherein a GUID is based at least in part on the device information for the device that it uniquely identifies.

6. A method according to claim 5, wherein a request comprises a GUID and the piece of device metadata sent in response is for the peripheral device that corresponds to the GUID.

7. A method according to claim 1, wherein the pieces of device metadata are structured so that different computers with different peripheral devices can use the pieces of device metadata to manage their peripheral devices.

8. A method according to claim 1, wherein the units of device metadata are sent or delivered by vendors that make and/or sell the different devices.

9. A computer-implemented method according to claim 1, wherein the pieces of device metadata describe functional attributes and/or appearances of peripheral devices configured to be connected with computers by a bus, connector, or network interface.

10. A method according to claim 1, wherein a piece of device metadata is dynamically extended with new device metadata further describing the device corresponding to the piece of device metadata.

11. A method according to claim 1 further comprising receiving via the network a query for device metadata that matches a search criteria, retrieving pieces of device metadata that match the criteria and sending them to a computer that sent the query.

12. A method according to claim 1, wherein the pieces of device metadata are configured to allow requesting computers to manage corresponding peripheral devices.

13. A method according to claim 1, wherein at least some of the pieces of device metadata comprise indicia of hardware connectors and/or hardware controls of the corresponding peripheral devices.

14. A volatile or non-volatile computer-readable medium storing information for enabling a computer to perform a process, the process comprising:
sending, via a network, to a device metadata intermediary, information about or identifying a peripheral device connected with the computer; and
receiving via the network from the device metadata intermediary a piece of hierarchically structured extensible device metadata comprising detailed device information about the device, wherein the device metadata conforms to a standard device metadata schema.

15. A volatile or non-volatile computer-readable medium according to claim 14, further comprising displaying a graphical user interface with which a user inputs the information identifying or about the peripheral device.

16. A volatile or non-volatile computer-readable medium according to claim 14, wherein the detailed device information comprises indicia of specific attributes of the device and appearance information enabling the computer to display a representation of the peripheral device closely corresponding to the actual appearance of the peripheral device.

17. A volatile or non-volatile computer-readable medium according to claim 16, further comprising the computer using the detailed device information to configure a user interface to display a realistic two or three dimensional representation of the peripheral device and to allow a user to manage the peripheral device.

18. A volatile or non-volatile computer-readable medium according to claim 17, wherein in response to the sending of the information about or identifying a peripheral device the computer receives a list of matching peripheral devices, the computer displays the list of matching peripheral devices, and one of the peripheral device listings is selected to select device metadata as the device metadata of the peripheral device.

19. A volatile or non-volatile computer-readable medium according to claim 14 wherein the detailed information of the received device metadata comprises functional attributes of the peripheral device, including: switches of the peripheral device, or hardware controls of the peripheral device, or hardware connectors of the peripheral device, or other hardware for controlling the device.

20. A volatile or non-volatile computer-readable medium storing information for enabling a computer to perform a process, the process comprising:
automatically detecting exposure of new functionality of a peripheral device previously and currently connected with the computer;
in response to the detecting, sending via a network to a device metadata intermediary a GUID corresponding to the peripheral device connected with the computer; and
receiving via the network from the device metadata intermediary a piece of hierarchically structured extensible device metadata comprising detailed device information about the device, where the device metadata conforms to a standard device metadata schema, and where the device metadata includes extended metadata corresponding to the newly exposed functionality of the peripheral device.
